(19) United States
(12) Patent Application Publication
(10) Pub. No.: US 2017/0290436 A1
(43) Pub. Date: Oct. 12, 2017

(54) RESONATING MEDITATION PLATFORM

(71) Applicant: Toby James Welsh, Wellington, FL (US)

(72) Inventor: Toby James Welsh, Wellington, FL (US)

(21) Appl. No.: 15/096,217

(22) Filed: Apr. 11, 2016

(51) Int. Cl. A47C 9/00; A61H 23/00; H04R 1/02; A47C 7/72

(52) U.S. Cl. CPC A47C 9/002; A47C 7/72; A61H 23/00; H04R 1/028; H04R 2400/03

(57) ABSTRACT

This Invention is designed to provide relaxation and sound healing properties to person while they practice seated meditation on a low profile and portable platform. The platform can play stereo sounds while transferring the sounds resonant vibrations to the user via direct contact to the platforms top surface. This is achieved by a combination of any top surface material capable of resonating such as wood or slate, which is also capable of supporting the user and the use of powered sound exciters designed for the sole purpose of producing sound via connection to such a surface. This platform is primarily designed to enhance the practice of meditation to help reduce stress and create a deep sense of relaxation peace and well being.

### CROSS REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPEX

Not Applicable

### BACKGROUND OF INVENTION

This Invention is designed to provide a person who meditates a low profile and portable platform that will play both stereo sound and provide resonant vibrations from that music or sound frequency to the user via direct contact to the platforms top surface. This is achieved with a combination of any preferred top surface material such as wood or slate that is also capable of supporting the user together with the use of powered sound exciters designed for the sole purpose of producing sound via a connected surface capable of resonating.

This devices concept and invention came about due to my personal interest and research in both Meditation techniques and Cymatics. Cymatics, from Greek: κũμα, meaning “wave”, is a subset of modal vibrational phenomena. The term was coined by Hans Jenny (1904-1972), a Swiss follower of the philosophical school known as anthroposophy. Typically the surface of a plate, diaphragm or membrane is vibrated, and regions of maximum and minimum displacement are made visible in a thin coating of particles, paste or liquid. Different patterns emerge in the excitatory medium depending on the geometry of the plate and the driving frequency. The apparatus employed can be simple, such as the old Chinese singing bowl, in which copper handles are rubbed and cause the copper bottom elements to vibrate. Other examples include the Chladni Plate and the so-called cymascope.)

In my research on the use of sound and vibration techniques I learned that from the continued ancient use of singing bowls and tuning forks to the current day use of specifically tuned frequency recordings to aid in general meditation and sound healing practices, that the main thought process behind this concept is that the field of endeavor known as sound healing is an effective modality that uses vibrational sound to help reduce stress, alter consciousness and create a deep sense of peace and well being.

I began to experiment with applying these frequency vibrations directly to my own person with a range of tuning forks and then a small self contained sound exciter designed to turn objects such as a cardboard box or window pane into a speaker when powered by an MP3 player. I decided to scale up the idea so I could enjoy both the sounds and the frequency vibrations easily through my whole person. I created a basic wooden plate on a raised platform which houses a pair of left and a pair of right hand positioned sound exciters directly under the wooden top plate which are powered by a small amplifier.

### BRIEF SUMMARY OF INVENTION

This Invention is designed to provide relaxation and sound healing properties to person while they practice seated meditation on a low profile and portable platform. The platform can play stereo sounds while transferring the sounds resonant vibrations to the user via direct contact to the platforms top surface. This is achieved by a combination of any top surface material capable of resonating such as wood or slate, which is also capable of supporting the user and the use of powered sound exciters designed for the sole purpose of producing sound via connection to such a surface. This platform is primarily designed to enhance the practice of meditation to help reduce stress and create a deep sense of relaxation, peace and well being.

### BRIEF DESCRIPTION OF DRAWINGS

FIG. 1 is a top view of the platform showing (1) integrated carry handle (2) power cord (3) audio input connection.

FIG. 2 is a front view of the platform showing (4) the amplifier with controls: on/off, volume, bass, treble and a USB charging port.

FIG. 3 is an underside view of the platform showing base plate and rubber feet (5).

FIG. 4 is a back view of the platform showing (2) power cord.

FIG. 5 is an underside view with the base plate/cover removed showing the electrical components inside the housing including (6) sound exciters (4) amplifier (2) Power cord & (3) audio input connection.

FIG. 6 is a left & right side view of the platform showing (7) side vents to allow the sound a way out.

FIG. 7 is front view showing (8) seated position of user.

FIG. 8 is a photograph of the first prototype.

### DETAILED DESCRIPTION OF INVENTION

This Invention is designed to provide relaxation and sound healing properties to a person while they practice seated meditation on a low profile and portable platform. The platform can play stereo sounds while transferring the sounds resonant vibrations to the user via direct contact to the platforms top surface. This invention uses sound exciter type speakers that are specifically designed to mount directly to a surface that is capable of resonating which will then provide both audible sound and physical vibration through that surface. The top of the platform can be made from any material that is strong enough to support a person on it while also being capable of resonating—for example wood, plastic or slate. The top platform complete with the attached sound exciters is mounted to a frame and bottom platform to create a low profile enclosed space in which the sound exciters, electrical wires and amplifier are all housed.

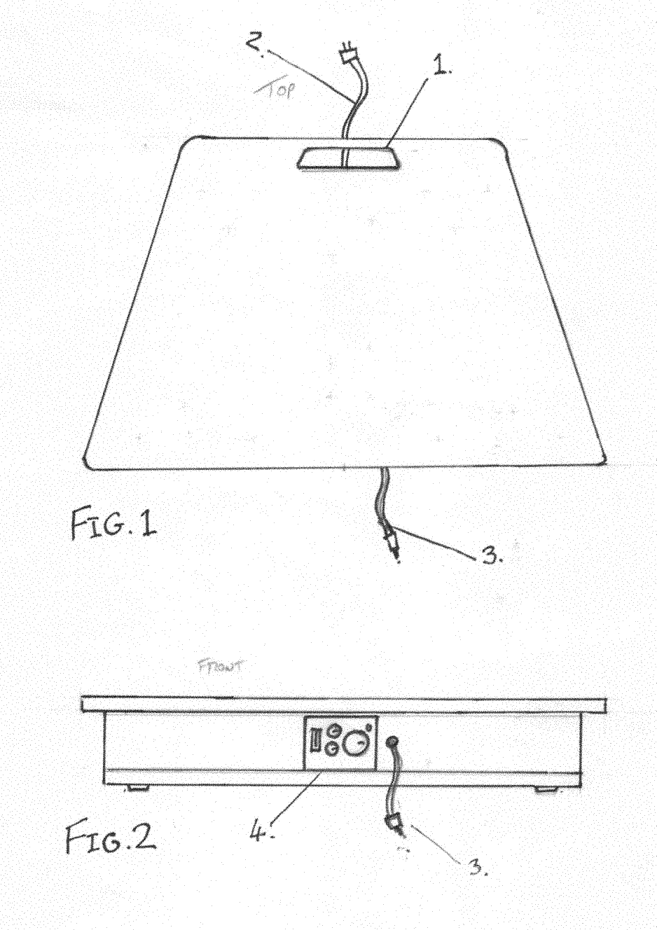

Referring to FIG. 1, showing a top view of the platform including (1) a carry handle for portability.

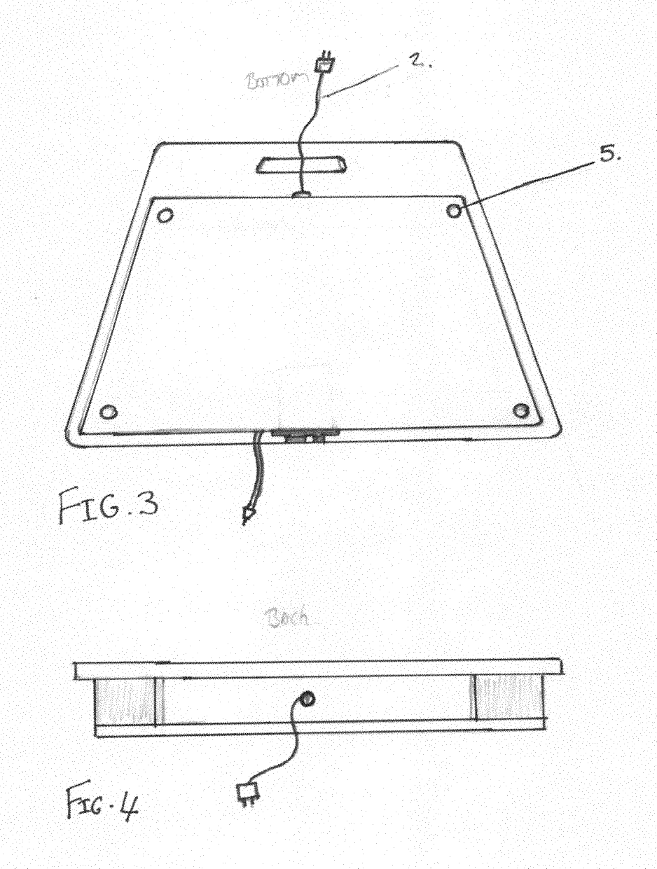

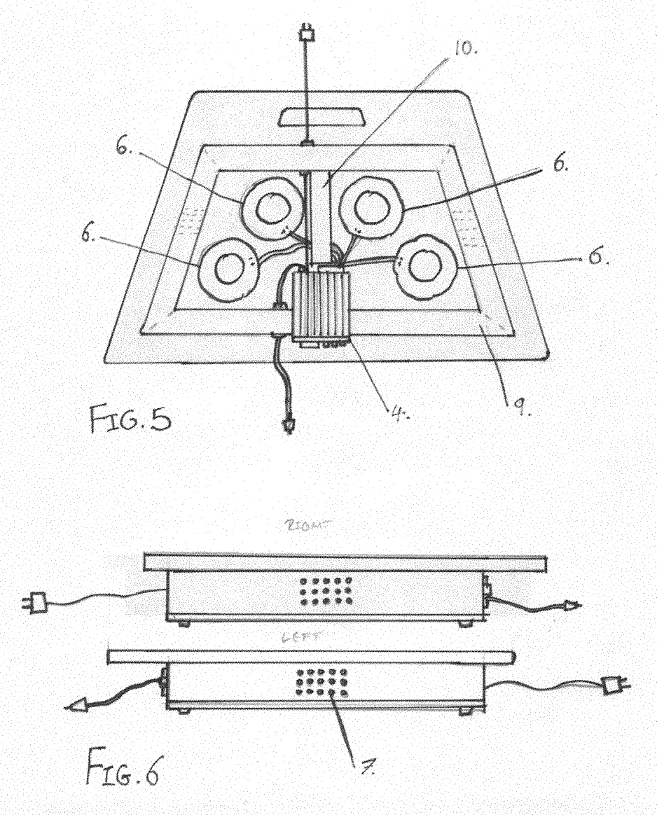

Referring to FIG. 2, showing a front view of the platform including (4) a powered audio amplifier based on the requirement of the sound exciters, this amplifier has volume, bass and treble controls, a USB charging output and an on/off switch, (3) shows an audio input cable to enable the user to connect any number of compatible sound players.

Referring to FIG. 3, this shows an underside view with (2) power cord & (5) small rubber feet mounted to each corner of the base to minimize wear to the platform or the surface it is placed upon.

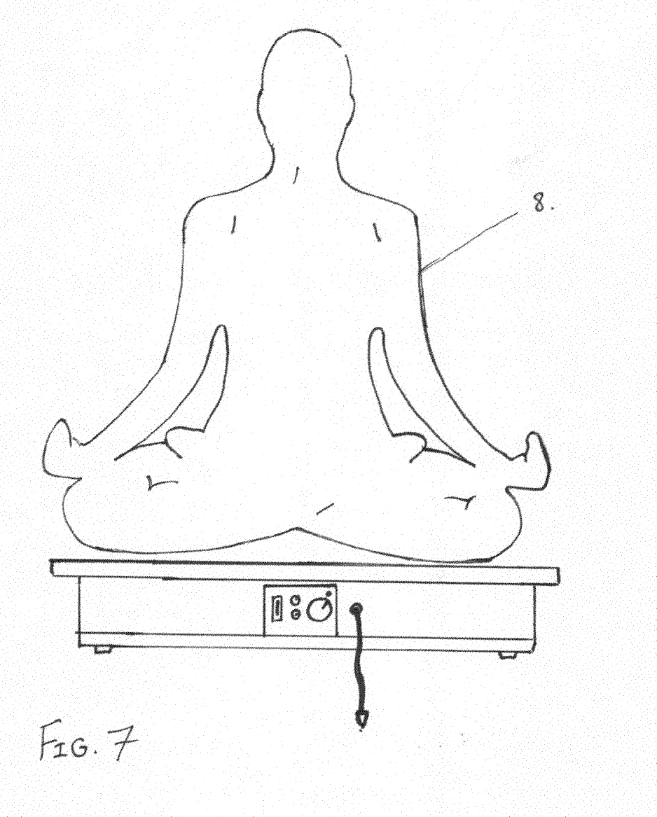

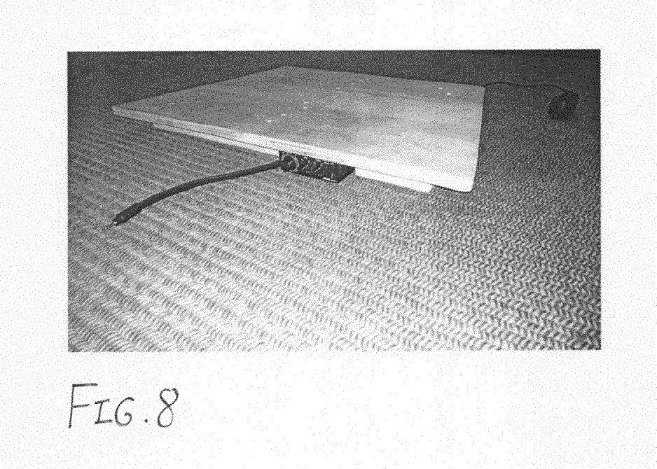

referring to FIG. 5, showing a view of the underside with the base of the platform removed, here you can see (4) the location of the amplifier, power and audio cables and (6) 2 left and 2 right sound exciters mounted directly to the underside of the top plate. Visible in this drawing is also (9) the supportive frame running around the outside of the components and (10) a dividing section to keep the left/right sounds from overlapping inside the unit. This frame will be glued and/or screwed in place between the top and bottom plates of the platform providing access via the bottom plate for servicing or repair. Referring to FIG. 6, showing both the left and right side views with (7) side vents to allow the audible sound to be delivered to the user in stereo.

The invention can be powered by standard electrical connection to the amplifier or by a portable power source such as a rechargeable battery pack which would also be fully enclosed within the unit. The unit has a built in carry handle in the top platform. The top platform is also shaped as (but not limited to) a trapezoid to accommodate a person seated in a cross legged meditation pose. The unit can easily be stored under a bed or located in a corner for ease of use, it is also designed to accommodate meditation cushions and mats as preferred by the user. Audio can be connected by direct cable input to the amp or by Bluetooth or similar wireless technology. The sound exciters and amplifier can both be specifically rated and powered to provide the correct amount of sound and vibration through the top platform material. The top plate can also be contoured on the top side to provide more comfort to the seated user; likewise the unit can also be created with a soft material on top of the top platform.

This invention is very easy to use, just connect an audio source and place yourself in direct contact with the top plate or use a meditation cushion between yourself and the platform for comfort, set the volume, bass and treble control per your preference and enjoy both the audio provided and the vibration that accompanies it via the resonation top plate.

The terms and expressions which have been employed herein are used as terms of description and not as limitation, and there is no intention in the use of such terms and expressions of excluding equivalents of the features shown and described or portions thereof, it being recognized that various modifications are possible within the scope of the invention claimed. Although particular embodiments of the present invention have been illustrated in the foregoing detailed description, it is to be further understood that the present invention is not to be limited to just the embodiments disclosed, but that they are capable of numerous rearrangements, modifications and substitutions.

What is claimed is:

1. A meditation and relaxation platform comprising: a top plate made of a material capable of resonating via the use of directly mounted sound exciters, a supportive frame, an amplifier, power source, audio device input and a base plate.

2. A meditation and relaxation platform that provides; audible stereo sound and its accompanying tactile vibration via resonation through the platforms own housing.

3. An enclosed meditation and relaxation audio & vibration platform that is designed to be portable, rechargeable or alternatively can be powered by a direct electrical power source.
